(19) United States
(12) Patent Application Publication
(10) Pub. No.: US 2015/0165969 A1
(43) Pub. Date: Jun. 18, 2015

(54) SEAT HAPTIC DEVICE OF VEHICLE

(71) Applicants: Hyundai Motor Company, Seoul (KR); Kia Motors Corporation, Seoul (KR)

(72) Inventors: Ju Hyun CHA, Seoul (KR); Sang Do Park, Suwon-si (KR); Hyun Ko, Hwaseong-si (KR); Jun Yeol Heo, Suwon-si (KR); Dong Woo Jeong, Seongnam-si (KR)

(73) Assignees: Hyundai Motor Company, Seoul (KR); Kia Motors Corporation, Seoul (KR)

(21) Appl. No.: 14/512,980

(22) Filed: Oct. 13, 2014

(30) Foreign Application Priority Data
Dec. 18, 2013 (KR) 10-2013-0157786

(51) Int. Cl. B60Q 9/00; H02K 5/04; H02K 33/00; H02K 1/17

(52) U.S. Cl. CPC B60Q 9/00; H02K 1/17; H02K 5/04; H02K 33/00

(57) ABSTRACT

A seat haptic device of a vehicle may include a hollow motor case of which an upper end portion is open, a shaft inserted in an axial direction into the motor case and rotatably supported at least in part by the motor case, an eccentric plumb attached to one side of the shaft to generate an eccentric force in rotation of the shaft, a rotor attached to the other side of the shaft, the rotor having magnetism when applied with a current, a stator installed in the motor case and spaced apart from the rotor at a predetermined interval, a cover configured to open/close the upper end portion of the motor case, the cover having a current supply pin for supplying the current to the rotor, and a current applying means configured to electrically connect the rotor and the current supply pin.

### CROSS-REFERENCE TO RELATED APPLICATION

The present application claims priority of Korean Patent Application Number 10-2013-0157786 filed on Dec. 18, 2013, the entire contents of which application are incorporated herein for all purposes by this reference.

### BACKGROUND OF INVENTION

1. Field of Invention

The present invention relates to a seat haptic device installed in the back of a driver's seat in a vehicle. More particularly, the present invention relates to a seat haptic device of a vehicle, which warns a driver when a dangerous situation occurs during a vehicle drive.

2. Description of Related Art

In general, if only a driver copes with a dangerous situation where a vehicle is always faced during driving, it is insufficient to reduce the risk of an accident.

For example, when the driver does not recognize the deviation of a traffic lane in advance due to bad weather, drowsiness or the like while driving a vehicle, a serious accident may occur.

However, if the driver receives a warning about a dangerous situation from the vehicle while driving, the driver can better cope with dangerous situations, regardless of the driver's ability.

Accordingly, research has been focused on developing a technique for warning a driver when a dangerous situation occurs while driving a vehicle. FIG. 6 shows an example of a conventional seat haptic device of a vehicle, which warns a driver in a dangerous situation while driving the vehicle.

As shown in FIG. 6, the conventional seat haptic device is configured in which a coreless vibration motor 2 is driven by being inserted and installed in a cushion pad 1 of a seat, so as to warn a driver of a dangerous situation.

In the conventional seat haptic device, a separate motor case 4 is used so that the vibration motor 2 is mounted on a seat frame 3 inside the cushion pad 1, and the vibration motor 2 is separated from the motor case 4. Hence, before being inserted into the cushion pad 1, the vibration motor 2 is mounted in the motor case 4, and the motor cases 4 are then respectively mounted at both left and right sides in the cushion pad 1. Accordingly, some problems are caused as follows.

First, it is difficult to sufficiently secure a distance between the motor case having the vibration motor mounted therein and the cushion pad of the seat, and therefore, the driver feels that there is a foreign object in the seat when the driver gets on/off the vehicle.

Second, an assembly difference between the vibration motors respectively mounted at both the left and right sides in the cushion pad is generated according to a worker's operation, and therefore, a difference in vibration intensity between the vibration motors respectively mounted at both the left and right sides in the cushion pad is also generated.

Third, vibration is generated at both the left and right sides of the cushion pad even when only one of the vibration motors respectively mounted at both the left and right sides in the cushion pad is operated due to insufficient distance between the motor case and the cushion pad, and therefore, it is difficult to recognize which one of the vibration motors is operated.

Fourth, the quality of the product and the degree of user's satisfaction are lowered due to such problems, and therefore, an expensive imported product is used.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention provides a seat haptic device of a vehicle, in which a vibration motor assembly is integrally configured with a case so that the size of the vibration motor assembly can be decreased as compare with the existing vibration motor, and a motor mounting guide is mounted at a correct position in a cushion pad of a vehicle seat when the cushion pad is manufactured, so that it is possible to remove an assembly difference generated when the existing vibration motor is mounted in the cushion pad.

In various aspects, the present invention provides a seat haptic device of a vehicle that may include a hollow motor case of which an upper end portion is open, a shaft inserted in an axial direction into the motor case and rotatably supported at least in part by the motor case, an eccentric plumb attached to one side of the shaft to generate an eccentric force in rotation of the shaft, a rotor attached to the other side of the shaft, the rotor having magnetism when applied with a current, a stator installed in the motor case and spaced apart from the rotor at a predetermined interval, a cover configured to open/close the upper end portion of the motor case, the cover having a current supply pin for supplying the current to the rotor, and a current applying means configured to electrically connect the rotor and the current supply pin.

In an aspect, the motor case may have a plurality of latching projections protruded from an outer circumferential surface thereof, to be pressed and fastened in a motor mounting guide that is integrally or monolithically attached inside a cushion pad of a vehicle seat.

In another aspect, the shaft may be mounted to be rotatably supported by the cover and the motor case, and bearings for supporting the rotation of the shaft may be respectively mounted between one end of the shaft and the motor case, and between the other end of the shaft and the cover.

In still another aspect, the stator may include a pair of permanent magnets having different polarities from each other, and the permanent magnets may be mounted opposite to each other on an inner circumferential surface of the motor case.

In various other aspects, the present invention provides a seat haptic device of a vehicle that may include a vibration motor assembly and a motor mounting guide in which the vibration motor assembly is pressed and fastened. The motor mounting guide may be integrally or monolithically attached in a cushion pad of a vehicle seat. The vibration motor assembly may include a hollow motor case of which an upper end portion is open, a shaft inserted in an axial direction into the motor case and rotatably supported at least in part by the motor case, an eccentric plumb attached to one side of the shaft to generate an eccentric force in rotation of the shaft, a rotor attached to the other side of the shaft, the rotor having magnetism when applied with a current, a stator installed in the motor case and spaced apart from the rotor at a predetermined interval, a cover configured to open/close the upper end portion of the motor case, the cover having a current supply pin for supplying the current to the rotor, and a current applying means configured to electrically connect the rotor and the current supply pin.

Other aspects and exemplary embodiments of the invention are discussed infra.

As described above, the seat haptic device of the vehicle according to the present invention have advantages as follows.

First, since the motor mounting guide integrally configured in the cushion pad is fixed at a correct position, the assembly position of the vibration motor assembly is constant, so that it is possible to remove an assembly difference generated when the vibration motor assembly is mounted in the cushion pad. Accordingly, it is possible to prevent the generation of a difference in vibration intensity between the vibration motors respectively mounted at both the left and right sides in the cushion pad.

Second, the size of the vibration motor assembly can be decreased as compared with the existing vibration motor, so that it is possible to increase the interval between the vibration motor assembly and the cushion pad of the seat. Thus, the driver hardly feels that there is a foreign object in the seat when the driver gets on/off the vehicle.

Third, accordingly, the quality of the product and the degree of user's satisfaction are increased, so that it is unnecessary to use an expensive imported product, thereby reducing cost.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows an exploded perspective view of an exemplary vibration motor assembly, illustrating a seat haptic device of a vehicle according to the present invention;

FIG. 2 shows assembled and cutaway perspective views of an exemplary vibration motor assembly, illustrating a seat haptic device of the vehicle according to the present invention;

FIG. 3 shows a sectional view taken along line A-A of the vibration motor assembly of FIG. 2, illustrating an arrangement structure among an electromagnet, a permanent magnet and a shaft;

FIG. 4 shows a state in which an exemplary vibration motor assembly is mounted in a cushion pad of a vehicle seat according to the present invention;

FIG. 5 illustrates a coupling structure between an exemplary vibration motor assembly and a motor mounting guide according to the present invention; and

FIG. 6 shows a conventional seat haptic device of a vehicle.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

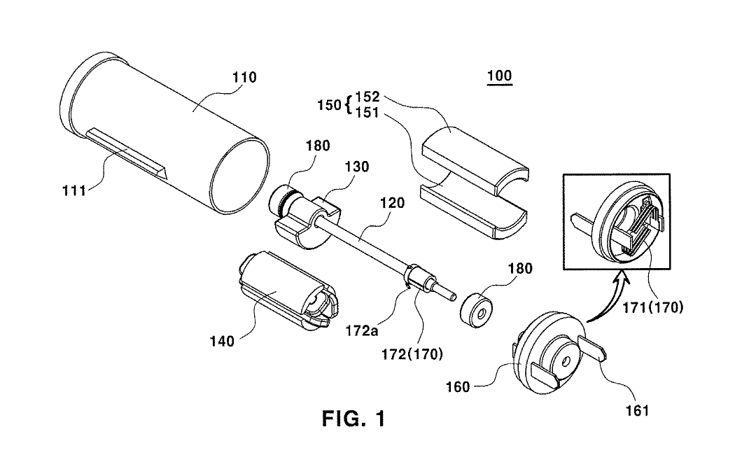

A seat haptic device of a vehicle according to various embodiments of the present invention is configured to include a vibration motor assembly that is a core-type motor integrally formed with a case shown in FIG. 1.

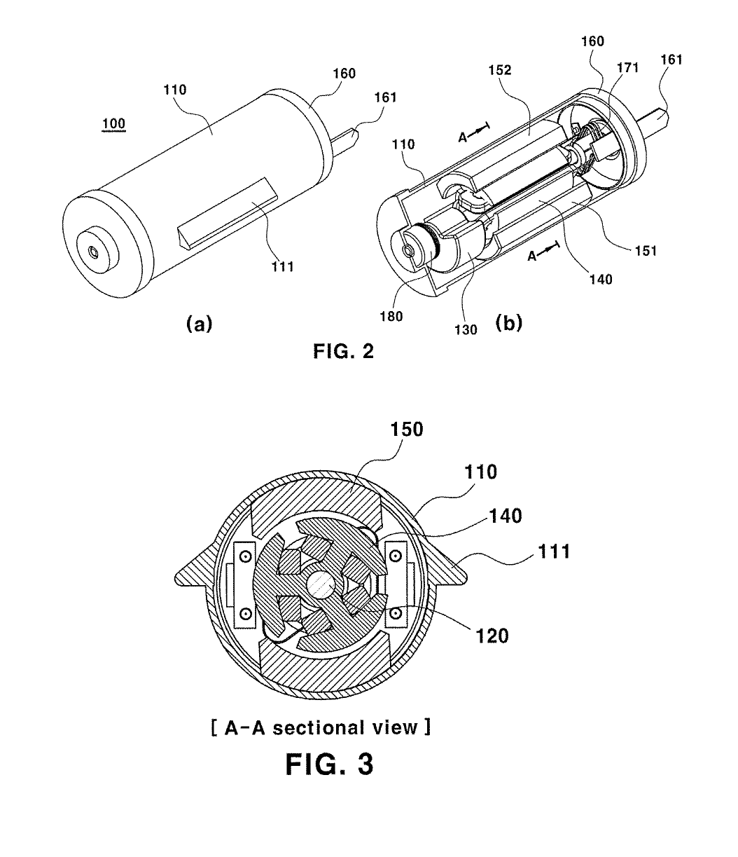

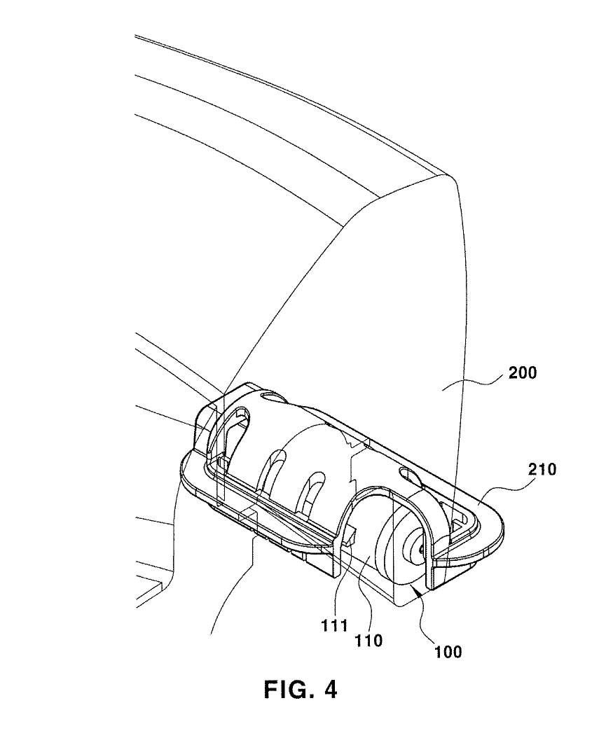

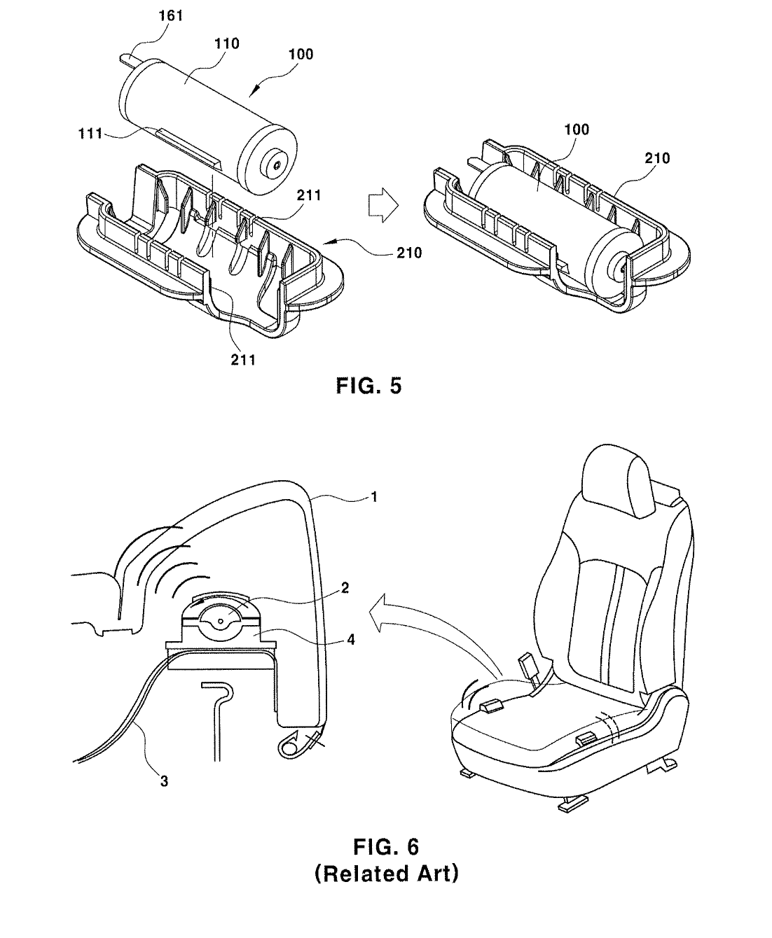

As shown in FIGS. 1 and 2, the vibration motor assembly 100 includes a motor case 110, a shaft 120, an eccentric plumb 130, a rotor 140, a stator 150, a cover 160, a current applying means 170 and bearings 180.

The motor case 110 is provided in the shape of a hollow cylinder or the like, of which an upper end portion is open. The shaft 120 is inserted in an axial direction into the motor case 110 to be rotatably supported and assembled.

The eccentric plumb 130 is integrally attached to one side of the shaft 120, to generate an eccentric force while simultaneously rotating when the shaft 120 rotates. Accordingly, vibration can be generated by the eccentric movement of the shaft 120.

The shaft 120 is mounted to be rotatably supported between the cover 160 and the motor case 110. To this end, the bearings 180 for supporting the rotation of the shaft 120 are respectively mounted between one end of the shaft 120 and the motor case 110, and between the other end of the shaft 120 and the cover 160.

The rotor 140 is formed with an electromagnet formed by winding a coil around an iron core (ferromagnetic body). The rotor 140 is inserted into the motor case 110 to be integrally attached to the shaft 120. When current is applied to the rotor 140, the rotor 140 is magnetized to act as a magnet having a polarity.

The stator 150 is configured with first and second permanent magnets 151 and 152 having different polarities from each other. The permanent magnets 151 and 152 are disposed opposite to each other, to be attached to the inner circumferential surface of the motor case 110.

As shown in FIG. 3, the stator 150 is spaced apart from the rotor 140 at a predetermined interval so that the rotor 140 can perform a smooth rotary motion.

The cover 160 is used to open/close the open upper end portion of the motor case 110. The cover 160 is provided with a pair of current supply pins 161 for supplying external current to the rotor 140.

The current applying means 170 is used to apply the external current supplied through the current supply pins 161 to the rotor 140. The current applying means 170 is configured to include a brush 171 and a commutator 172, which are electrically connected between the rotor 140 and the current supply pins 161. Here, the brush 171 and the commutator 172 may be the same as or similar to those known in the art.

The brush 171 is used to electrically connect between the current supply pins 161 and the commutator 172. The brush 171 is attached to each of the pair of current supply pins 161 to apply the current supplied through the current supply pins 161 to the commutator 172.

The commutator 172 is used to control and change the flow direction of current supplied to the rotor 140 so that the rotor 140 is rotated in a predetermined direction. The commutator 172 is provided with commutator pieces 172a having the same number of coils (wound coils) of the rotor 140 insulated therewith, and current is supplied to the rotor 140 through contact between each commutator piece 172a and the brush 171.

That is, the current applying means 170 is configured similarly or identically to a current applying means known in the art. Here, the current applying means is a component in a general core-type DC motor, which applies current to a rotor inside the motor.

Thus, if external current is supplied through the current supply pins 161 provided in the cover 160, the current is applied to the rotor 140 through the brush 171 and the commutator 172, which are electrically connected to the current supply pins 161, and an electromagnetic force is generated by Fleming's left-hand rule. As the rotor 140 has magnetism by means of the electromagnetic force, the rotor 140 rotates, and simultaneously, the eccentric plumb 130 rotates, thereby generating vibrations.

The intensity of the vibration generated by the rotation of the eccentric plumb 130 may be calculated using the following Equation 1 through Weber's law:

F=mrω² (Equation 1)

Here, F is an intensity of the vibration generated in the vibration motor assembly, m is a mass of the eccentric plumb, r is a distance from the center to the outermost portion of the vibration motor assembly, and w is an angular speed. For example, when m is 9 g, r is 10 mm, and co is 5 rad/sec, F becomes 2250 N.

Meanwhile, the motor case 110 has latching projections 111 respectively protruded at both sides on the outer circumferential surface thereof, to be mounted in a motor mounting guide 210.

The motor mounting guide 210 has a plurality of fastening ribs 211 protruded inward on the inner wall surface thereof. Thus, when the motor case 110 having the latching projections 111 is inserted into the motor mounting guide 210, i.e., when the vibration motor assembly 100 is inserted into the motor mounting guide 210, the motor case 110 is pressed and fastened in the motor mounting guide 210, to be fixedly mounted in the motor mounting guide 210.

The motor mounting guide 210 is integrally or monolithically attached inside a cushion pad 200 of a vehicle seat. The cushion pad 200 is manufactured by an injection molding method using the motor mounting guide 210 as an insert, so that the motor mounting guide 210 is integrally or monolithically configured inside the cushion pad 200.

Accordingly, when the cushion pad 200 is manufactured, the motor mounting guide 210 is fixedly mounted by being disposed at a correct position, so that it is possible to remove an assembly difference generated when the existing vibration motor is mounted in the cushion pad. Thus, it is possible to prevent the generation of a difference in vibration intensity between the vibration motors respectively mounted at both the left and right sides in the cushion pad.

Further, the size of the vibration motor assembly 100 can be decreased as compared with the existing vibration motor, so that it is possible to increase the interval between the vibration motor assembly 100 and the cushion pad of the seat. Thus, the driver hardly feels that there is a foreign object in the seat when the driver gets on/off the vehicle.

Accordingly, the quality of the product and the degree of user's satisfaction are increased, so that it is unnecessary to use an expensive imported product, thereby reducing cost.

For convenience in explanation and accurate definition in the appended claims, the terms “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A seat haptic device of a vehicle, comprising:
a hollow motor case of which an upper end portion is open;
a shaft inserted in an axial direction into the motor case and rotatably supported at least in part by the motor case;
an eccentric plumb attached to one side of the shaft to generate an eccentric force in rotation of the shaft;
a rotor attached to the other side of the shaft, the rotor having magnetism when applied with a current;
a stator installed in the motor case and spaced apart from the rotor at a predetermined interval;
a cover configured to open/close the upper end portion of the motor case, the cover having a current supply pin for supplying the current to the rotor; and
a current applying means configured to electrically connect the rotor and the current supply pin.

2. The seat haptic device of claim 1, wherein the motor case has a plurality of latching projections protruded from an outer circumferential surface thereof, to be pressed and fastened in a motor mounting guide that is integrally or monolithically attached inside a cushion pad of a vehicle seat.

3. The seat haptic device of claim 1, wherein the shaft is mounted to be rotatably supported by the cover and the motor case, and bearings for supporting the rotation of the shaft are respectively mounted between one end of the shaft and the motor case, and between the other end of the shaft and the cover.

4. The seat haptic device of claim 1, wherein the stator includes a pair of permanent magnets having different polarities from each other, and the permanent magnets are mounted opposite to each other on an inner circumferential surface of the motor case.

5. A seat haptic device of a vehicle, comprising:
a vibration motor assembly; and
a motor mounting guide in which the vibration motor assembly is pressed and fastened,
wherein the motor mounting guide is integrally or monolithically attached in a cushion pad of a vehicle seat, and wherein the vibration motor assembly includes:
a hollow motor case of which an upper end portion is open;
a shaft inserted in an axial direction into the motor case and rotatably supported at least in part by the motor case;
an eccentric plumb attached to one side of the shaft to generate an eccentric force in rotation of the shaft;
a rotor attached to the other side of the shaft, the rotor having magnetism when applied with a current;
a stator installed in the motor case and spaced apart from the rotor at a predetermined interval;
a cover configured to open/close the upper end portion of the motor case, the cover having a current supply pin for supplying the current to the rotor; and
a current applying means configured to electrically connect the rotor and the current supply pin.
